(19) United States
(12) Patent Application Publication
(10) Pub. No.: US 2003/0136507 A1
(43) Pub. Date: Jul. 24, 2003

(54) Thermoformed fuel tank fuel delivery system and assembly method

(76) Inventors: Steven A. Thiel, Dexter, MI (US); Kelley B. Munn, Ypsilanti, MI (US); Harold Cunningham, Oxford, MI (US); Paul E. Fisher, Dexter, MI (US); Marco G. Toppi, Plymouth, MI (US); Larry D. Land, Grosse Ile, MI (US); David Galiyas, Dexter, MI (US)

Correspondence Address: BRINKS HOFER GILSON & LIONE, P.O. BOX 10395, CHICAGO, IL, 72610, US

(21) Appl. No.: 10/055,792

(22) Filed: Jan. 18, 2002

(51) Int. Cl. B65D 6/00; B32B 31/00

(52) U.S. Cl. 156/293; 220/4.13

(57) ABSTRACT

In one aspect of the invention, a method for assembling a fuel delivery system is provided. The method includes providing a reservoir assembly having a reservoir unit. The method also includes thermoforming a first shell portion and a second shell portion of a fuel tank. The method further includes fixing the reservoir assembly to one of the first and second shell portions. The method also includes sealingly connecting the first and second shell portions to form a fuel tank to enclose the reservoir assembly within the fuel tank.

### FIELD OF THE INVENTION

The present invention relates generally to a fuel delivery system for a vehicle and a method for assembling same. More particularly, it relates to a fuel delivery apparatus that is installed within a thermoformed fuel tank.

### BACKGROUND

Fuel delivery systems typically utilize a fuel pump and a reservoir unit located within a main fuel tank for pumping fuel out of the fuel tank to an engine. The fuel pump is fed from a reservoir, which stores fuel in a restricted volume to prevent fuel starvation at the inlet of the fuel pump during driving conditions that would otherwise leave the inlet unimmersed in fuel. An auxiliary pump is also typically provided to keep the reservoir full by pumping fuel from the fuel tank into the reservoir.

It is known to produce a fuel tank shell from plastic using a thermoforming process. Moreover, it is known to assemble a fuel tank shell from two thermoformed half shell portions sealingly assembled together by means of a continuous weld seam. Typically, a fuel delivery module combining a fuel pump and a reservoir is inserted into the fuel tank and installed therein through an opening in the fuel tank shell after the fuel tank shell is sealingly assembled. One of the disadvantages of the aforementioned assembly process is that the fuel delivery module is typically limited in size and shape by the diameter of this fuel tank opening, for example, a cylinder of a certain diameter. Moreover, the component content of the fuel delivery module is also restricted. For example, the capacity of the reservoir is limited by the size and shape of the fuel delivery module. Likewise, other components commonly utilized in fuel delivery systems, such as a fuel filter, will also have limited capacity unless mounted externally to the fuel tank. However, external mounting of components increases the number of openings needed in the fuel tank shell and therefore increases hydrocarbon permeation to the outside of the fuel tank.

Alternatively, known fuel delivery systems utilize a reservoir that is formed integrally in one piece with a fuel tank shell portion. This approach avoids the size restriction on the reservoir imposed by a fuel tank insertion opening as mentioned above. The disadvantage of this assembly is that it is limited to a process capable of forming the reservoir in one piece with the fuel tank shell, such as an injection molding process. Moreover, such a process imposes design constraints limiting the type of components that could be successfully attached to the integrally formed reservoir unit in a way that permits their subsequent removal for service. Any design changes that are made to the reservoir unit or to any of the module componentry require costly changes in the tooling and other processes used to form the fuel tank shell and reservoir.

In the area of fuel delivery systems, there continues to be a need for a fuel delivery system that allows a fuel delivery module for use in a thermoformed fuel tank to assume the shape that is most desirable for a particular design and component content and for easy serviceablity.

### SUMMARY

In one aspect of the invention, a method for assembling a fuel delivery system is provided. The method includes providing a reservoir assembly having a reservoir unit. The method also includes thermoforming a first shell portion and a second shell portion of a fuel tank. The method further includes fixing the reservoir assembly to one of the first and second shell portions. The method also includes sealingly connecting the first and second shell portions to form a fuel tank to enclose the reservoir assembly within the fuel tank.

In another aspect of the invention, the method for assembling a fuel delivery system includes thermoforming a first shell portion and a second shell portion of a fuel tank. The method also includes providing a reservoir assembly having a reservoir unit. The method further includes fixing said reservoir assembly to one of the first and second shell portions. The method also includes sealingly connecting the first and second shell portions to form a fuel tank to at least partially enclose the reservoir assembly within the fuel tank. The method also includes forming a fuel tank access aperture in at least one of the first and second shell portions.

In another aspect of the invention, a fuel delivery system is provided. The fuel delivery system includes a plurality of thermoformed shell portions for a fuel tank. At least one of the thermoformed shell portions has a fuel tank access aperture.

The fuel delivery system further includes a non-integral reservoir assembly having a reservoir unit. The reservoir assembly has its smallest cross-sectional area being greater than the area of the fuel tank access aperture. The reservoir assembly is configured to store fuel and is attached to at least one of the thermoformed shell portions inside the fuel tank.

### BRIEF DESCRIPTION OF THE DRAWINGS

FIG. 1 is a perspective view of a fuel delivery system in accordance with the present invention;

FIG. 2 is a side view of a fuel delivery module of the fuel delivery system of FIG. 1;

FIG. 3 is a top view of a reservoir assembly of the fuel delivery module of FIG. 2;

FIG. 4 is a side view of a reservoir assembly of the fuel delivery module of FIG. 2;

FIG. 5 is a top view of a reservoir unit of the reservoir assembly of FIG. 3;

FIG. 6 is a side view of a reservoir unit of the reservoir assembly of FIG. 3;

FIG. 7 is a bottom view of a reservoir unit of the reservoir assembly of FIG. 3;

FIG. 8 is an enlarged fragmentary view of an auxiliary pump of the reservoir assembly of FIG. 4;

FIG. 9 is a side view of a weld foot of the reservoir assembly of FIG. 3;

FIG. 10 is a top view of a weld foot of the reservoir assembly of FIG. 3;

FIG. 11 is a front view of a weld foot of the reservoir assembly of FIG. 3;

FIG. 12 is a front view of a fuel pump of the reservoir assembly of FIG. 3;

FIG. 13 is a front view of a fuel filter of the reservoir assembly of FIG. 3;

FIG. 14 is a top view of a fuel pressure regulator assembly of the reservoir assembly of FIG. 3;

FIG. 15 is a side view of a fuel pressure regulator assembly of the reservoir assembly of FIG. 3;

FIG. 16 is a top view of a flange assembly of the fuel delivery module of FIG. 2;

FIG. 17 is a side view of a flange assembly of the fuel delivery module of FIG. 2;

FIG. 18 is a flowchart for a method of assembling a fuel delivery system in accordance with the present invention; and

FIG. 19 is a perspective view of another reservoir assembly in accordance with the present invention.

### DETAILED DESCRIPTION OF THE PREFERRED EMBODIMENTS

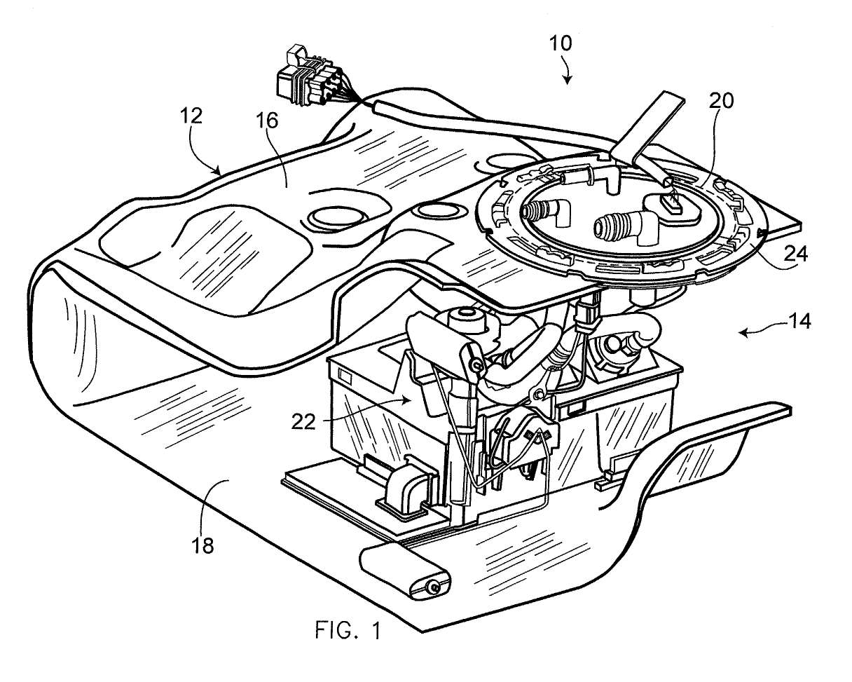

One preferred embodiment of a fuel delivery system 10, according to the present invention, is shown in FIG. 1. The fuel delivery system 10 includes a fuel tank 12 and a fuel delivery module, generally indicated at 14, that is mounted at least partially within the fuel tank 12. The fuel tank 12 comprises a first shell portion 16 and a second shell portion 18. The first shell portion 16 and the second shell portion 18 are each formed from a rigid material, preferably a plastic that can be thermoformed and more preferably a high-density polyethylene material. The shell portions 16 and 18 are joined together to form the fuel tank 12 in a manner described below. In this embodiment, the first shell portion 16 defines a fuel tank access aperture 20 at a location generally above the fuel delivery module 14. Those skilled in the art will recognize that the access aperture 20 may be alternatively defined by the first shell portion 16 or the second shell portion 18 at any location that allows access to the fuel delivery module 14 from the exterior of the fuel tank 12.

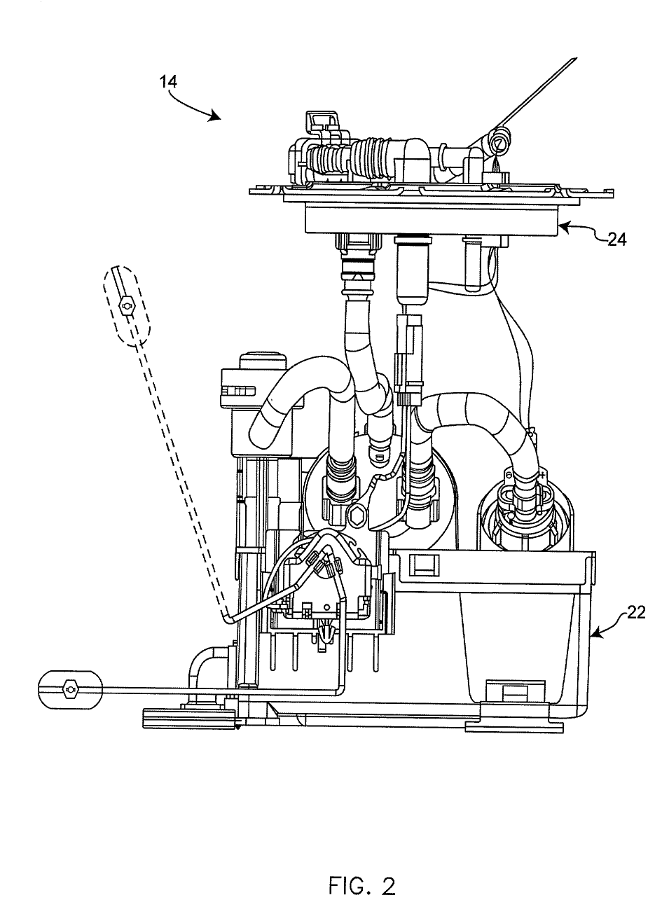

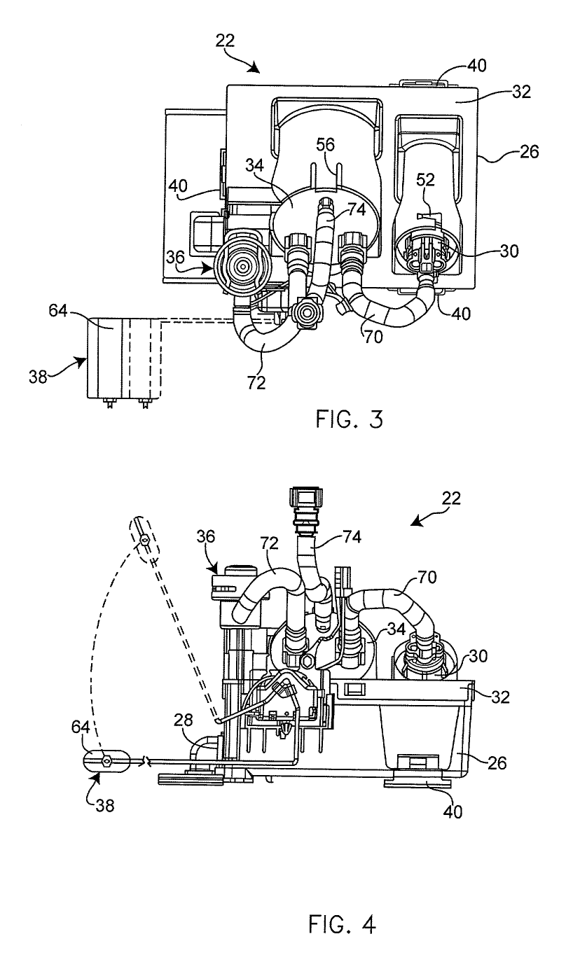

Referring next to FIG. 2, the fuel delivery module 14 includes a reservoir assembly, generally indicated at 22, and a flange assembly 24. The reservoir assembly 22 comprises a reservoir unit 26, an auxiliary pump 28, a fuel pump 30, a reservoir cover 32, an inline fuel filter assembly 34, a fuel pressure regulator assembly 36, and a level sensor assembly 38, as shown in FIGS. 3-4. The reservoir unit 26 preferably maintains a depth of fuel in the immediate vicinity of the fuel pump 30 such that the pump remains submerged during driving maneuvers that may cause fuel slosh in the fuel tank 12 and during low-fuel engine starts. This avoids starvation of the fuel pump 30 and enables it to provide an uninterrupted fuel supply to the engine (not shown) from the fuel tank 12 at generally constant pressure.

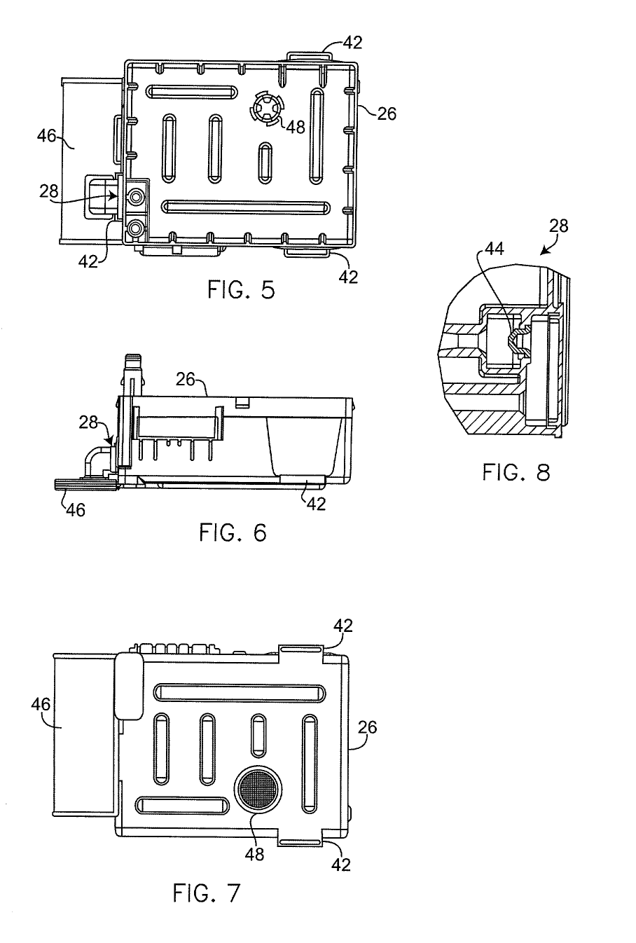

Referring next to FIGS. 5-7, the reservoir unit 26 has a generally rectangular shape and a usable volume that is dependent on design specifications and is usually specified as a minimum volume, for example 600 ml, in the present embodiment. In the present embodiment, the smallest cross-sectional area of the reservoir unit 26 is greater than the area of the fuel tank access aperture 20. Therefore, it is not possible to pass the reservoir unit 26 through the fuel tank access aperture 20. The reservoir unit 26 is preferably made of a rigid material such as plastic. Unlike prior art assemblies using a reservoir unit integrally formed with a shell portion, the reservoir unit 26, according to the present invention, is provided separately from the shell portions 16 and 18.

It is preferable in the present embodiment to install the fuel delivery module 14 at a location adjacent to the bottom surface of the fuel tank 12, as shown in FIG. 1. Accordingly, the reservoir unit 26 is attached to the second shell portion 18 using three weld feet 40, shown in FIGS. 3-4 and 9-11. The weld feet 40 are preferably molded from a material similar to the fuel tank 12 allowing them to be welded to the inside of the fuel tank 12 as described below. In the present embodiment, both the fuel tank shells portions 18 and 19 and the weld feet 40 are made of a high-density polyethylene material, although other plastic materials may also be used. The weld feet 40 are clipped to the lower sides of the reservoir unit 26 using the integral foot handles 42, shown in FIGS. 5-7.

In order to maintain the maximum fuel volume in the reservoir unit 26, an auxiliary pump 28 is provided as part of the fuel delivery module 14. The auxiliary pump 28 continually refills the reservoir unit 26 when the fuel pump 30 is operating. In the present embodiment, the auxiliary pump 28 preferably is a venturi-jet pump that is integral to the reservoir unit 26 and has a snap-fit nozzle 44, as shown in FIGS. 5-8. The auxiliary pump 28 is driven by diverting part of the flow quantity from the fuel pump 30 as a propellant jet for the auxiliary pump via the inline fuel filter 34 and the pressure regulator assembly 36. The auxiliary pump 28 utilizes a sock-type filter 46 to pick up fuel from the bottom of the fuel tank 12 and feed it into the reservoir unit 26. In order to minimize the volume of unusable fuel in the fuel tank 12, the sock-type filter 46 is positioned close to the bottom surface of the fuel tank 12, as described below.

To further assist in refilling the reservoir unit 26, a flapper valve 48 is provided on the bottom of the reservoir unit 26, as shown in FIGS. 5 and 7. The flapper valve 48 allows fuel to enter the reservoir unit 26 from fuel tank 12 and to prime the fuel pump 30 during initial fill and refilling of the fuel tank.

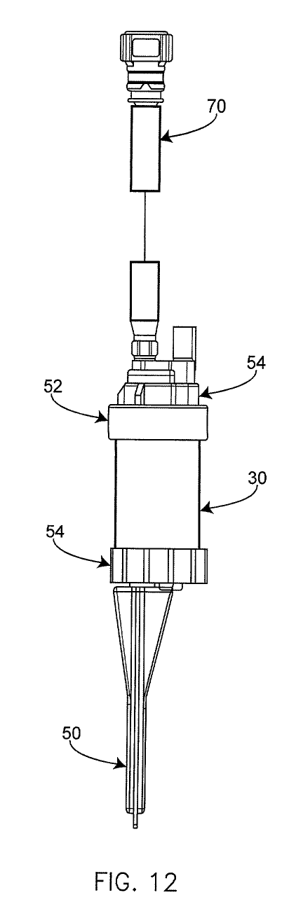

Referring to FIGS. 3-4 and 12, the fuel pump 30 is disposed in the reservoir unit 26 at an angle, for example 45 degrees, such that the inlet of the fuel pump is located at the deepest point of the reservoir unit. The fuel pump 30 is preferably of a turbine type although other types, such as an axial-flow type, may also be used. A cloth filter 50 is attached to the inlet of the fuel pump 30. In order to secure the fuel pump 30 into place and prevent fuel from sloshing out of the reservoir unit 26 during vehicle maneuvers, the fuel delivery module includes a reservoir cover 32. The fuel pump 30 is secured to the reservoir cover 32 using an injection-molded collar 52, which locks into a corresponding groove on the reservoir cover 32. The reservoir cover 32 is in turn attached to the reservoir unit 26, fixing the fuel pump 30 in place relative to the reservoir unit. The injection-molded collar 52 allows the fuel pump 30 to be easily removed and replaced for service. The pump 30 is mounted with rubber isolators 54 to reduce noise and vibration transmission through the fuel delivery module 14.

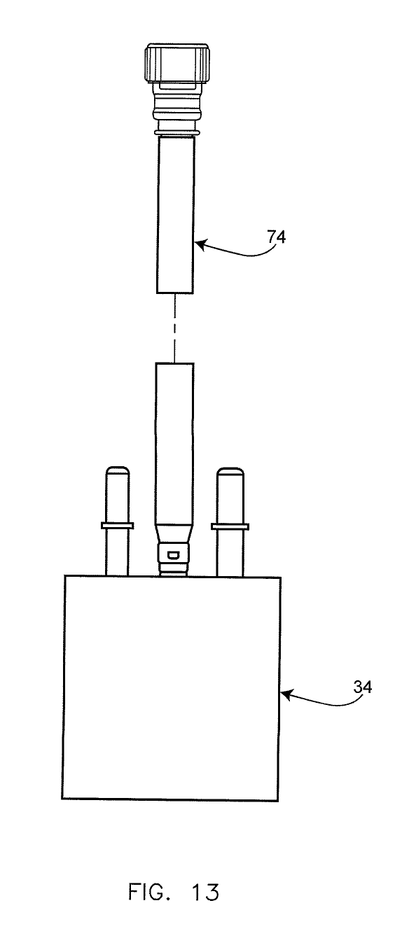

In the present embodiment, the reservoir assembly 22 further includes an inline fuel filter 34, as shown in FIGS. 3-4 and 13. The fuel pump 30 feeds the inline fuel filter 34 via the fuel pump hose 70 to supply clean filtered fuel flow to both the engine via the fuel supply hose 74 and the auxiliary pump 28 via the auxiliary pump supply hose 72. The hoses 70, 72 and 74 are preferably made of a conductive material to allow for electrical grounding and have quick-connect fittings for serviceability. The inline fuel filter 34 also mounts to the reservoir cover 32 in such a way that it can be removed for service. In the present embodiment, a retention tab 56 in the reservoir cover 32 attaches the cover to the inline fuel filter 34. In addition, those skilled in the art will recognize that the inline fuel filter 34 alternatively could be mounted outside the fuel tank 12.

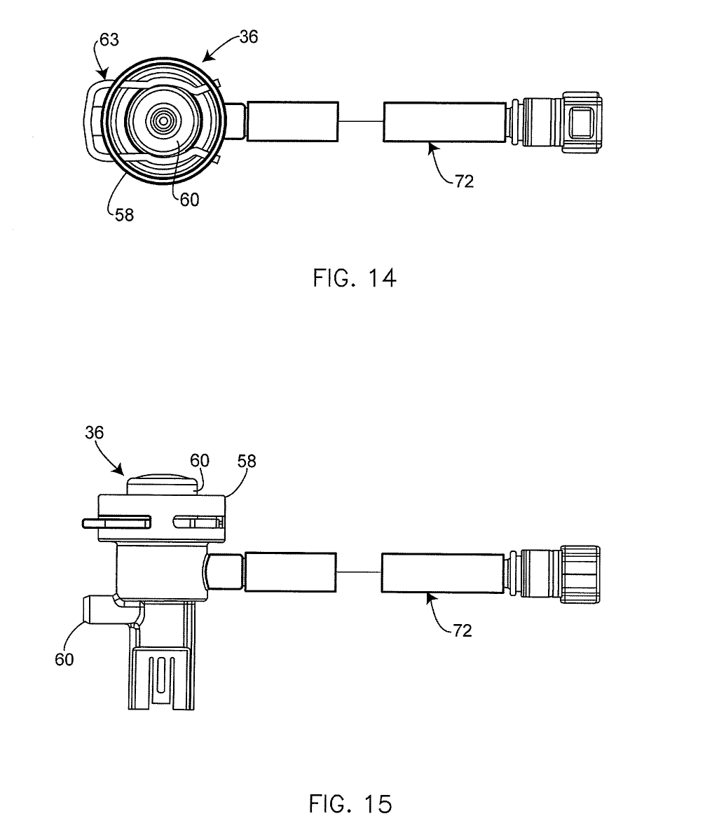

In order to maintain a constant pressure throughout the fuel delivery system 10, a fuel pressure regulator assembly 36 is provided as part of reservoir assembly 22, as shown in FIGS. 3-4. The fuel pressure regulator assembly 36 comprises a regulator retainer 58 and a pressure regulator 60, as shown in FIGS. 14-15. The regulator retainer 58 is preferably made of a conductive material to prevent electrostatic charge buildup and includes an over-pressure relief valve 62 in parallel to its output port. A mounting clip 59 allows the regulator retainer 58 to be removably attached to the reservoir unit 26. A snap fit connector 63 allows the pressure regulator 60 to be removably attached to the regulator retainer 58. In the present embodiment, for example, the fuel pressure regulator 60 can maintain a fuel line pressure of about 400 kPa, with any excess flow quantity diverted to the auxiliary pump 28 at about 200 kPa. Any further excess fuel flow is routed back to the reservoir unit via the over-pressure relief valve 62. It should be understood that these values are meant to be illustrative, rather than limiting. Other pressure ranges would also work depending on the particular design for the fuel tank, fuel delivery module and engine.

The reservoir assembly 22 further includes a level sensor assembly 38 mounted to the side of the reservoir unit 26, as shown in FIGS. 3-4. The level sensor assembly 38 sends a signal to a vehicle control module (not shown) indicative of the level of fuel within the fuel tank 12, which it detects utilizing a float rod 64.

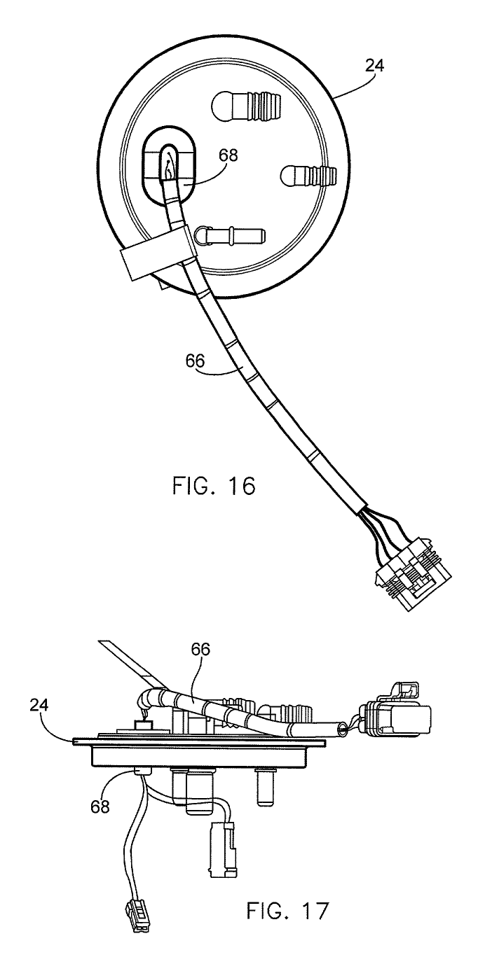

Referring to FIGS. 2 and 16-17, the fuel delivery module 14 also includes a flange assembly 24. The flange assembly 24 is preferably made of a conductive material to allow for electrical grounding. The flange assembly 24 has a welded-on pass-through wire harness 66 to provide electrical power to the fuel pump 30 and the level sensor assembly 38. The pass-through wire harness 66 has a non-conductive connector 68 to electrically isolate the current carrying wires from each other and the conductive flange assembly 24. The flange assembly 24 is secured in the fuel tank access aperture 20 using an o-ring or similar seal.

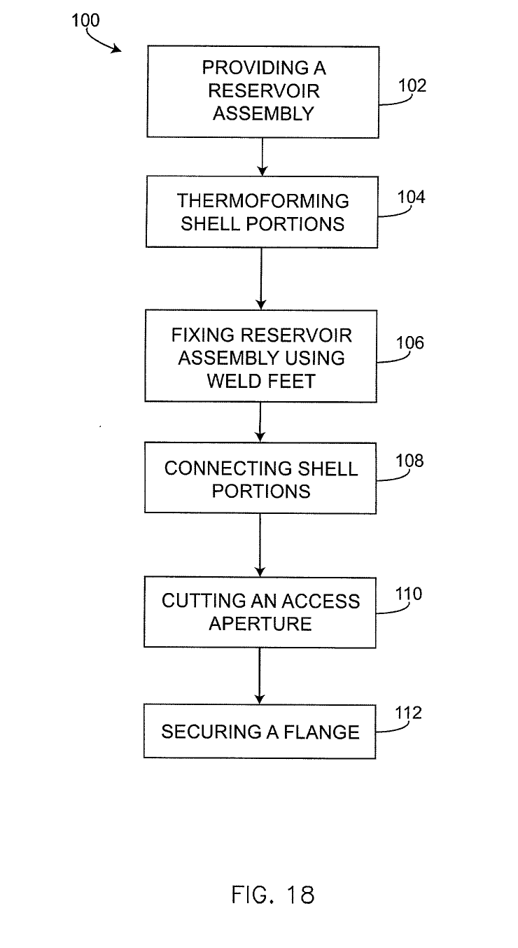

In order to assemble the fuel delivery system 10 discussed above, a method 100, according to the present invention, is shown in FIG. 18. The method 100 includes the step 102 of providing a fuel delivery module 14, including a reservoir assembly 22 having a reservoir unit 26 and weld feet 40 attached thereto, as shown in FIGS. 2-4. The method 100 further includes the step 104 of thermoforming a first shell portion 16 and a second shell portion 18 for a fuel tank 12. Specifically, for each shell portion 16 and 18, a plastic sheet, preferably made from a high-density polyethylene, is heated to between about 300 and 425 degrees Fahrenheit until it begins to soften. The heated plastic sheet is then vacuum formed inside a mold into the shape of one of the shell portions 16 and 18 comprising the fuel tank 12, shown in FIG. 1.

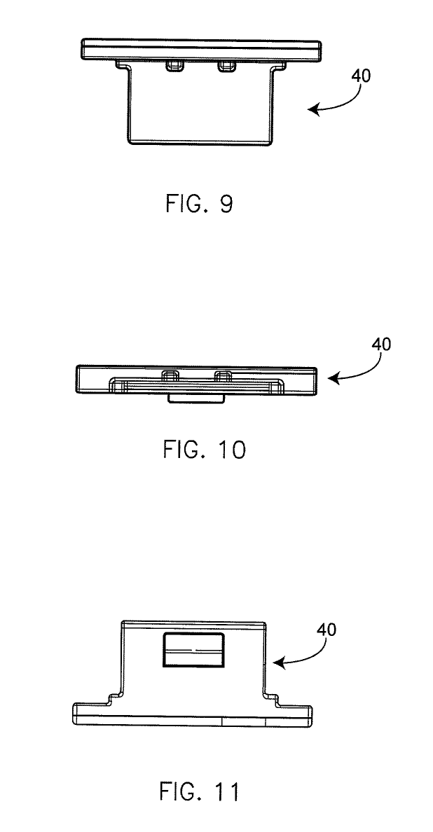

The method 100 also includes the step 106 of fixing the reservoir assembly 22 to the second shell portion 18. In the present embodiment, once the second shell portion 18 is thermoformed and while the material is still hot, the reservoir assembly 22 of the fuel delivery module 14 is positioned on the surface of the second shell portion 18 that forms part of the inner surface of the fuel tank 12, as shown in FIG. 1. The three weld feet 40 that are clipped to the reservoir unit 26 are then welded to the second shell portion 18. Specifically, the weld feet 40, shown in FIGS. 9-11, are preferably molded from the same material as the shell portions 16 and 18, such as a high-density polyethylene. Also, separate weld feet 40 are used rather than molded in to the reservoir unit 26 because the reservoir unit itself needs to withstand the temperature necessary during the assembly process to bond the weld feet 40 to the thermoformed shell portion 18, as described below. The weld feet 40, and in particular the weld foot contact surfaces, are pre-heated to about between 200 and 300 degrees Fahrenheit. With the material forming the weld feet 40 and the second shell portion 18 sufficiently plasticized, a permanent molecular bond is formed between the contact surface of each weld foot 40 and the second shell portion 18 once the weld feet are placed on the shell portion. As a result, the reservoir assembly 22 is fixedly attached to the surface of the second shell portion 18 that forms part of the inner surface of the fuel tank 12.

While it has been found useful to first preheat the weld feet 40 in order for them to form a strong bond with the second shell portion 18, those skilled in the art will recognize that this may not be necessary if the reservoir assembly 22 can be positioned on the second shell portion 18 immediately after thermoforming the shell portion.

In addition, the method 100 includes the step 108 of connecting the first shell portion 16 to the second half shell 18. With the reservoir assembly 22 attached to the second half shell portion 18, the thermoformed first shell portion 16 is brought into place and the two shell portions 16 and 18 are welded together to form the fuel tank 12, shown in FIG. 1. Again, this weld is made while the shell portions 16 and 18 are still hot to form a permanent, durable molecular bond between them. Once the shell portions 16 and 18 are sealingly joined together, they are allowed to cool briefly with the molds containing them pressed together.

Next, the method 100 includes the step 110 of cutting a fuel tank access aperture 20 in the first shell portion 16 preferably generally above the reservoir assembly 22 to allow access inside the fuel tank 12 once the molds are separated. In order to reduce hydrocarbon permeation to the outside of the fuel tank, the area of the fuel tank access aperture 20 is no larger than necessary to permit the removal of the serviceable components of the reservoir assembly, including the fuel pump 30 and the inline fuel filter 34. In the present embodiment, the fuel tank access aperture 20 has an area such that the reservoir unit 26 could not pass through the aperture.

The fuel tank 12 is then allowed to cool completely to room temperature. The method 100 also includes the step 112 of securing a flange assembly in the fuel tank access aperture 20. Specifically, the flange assembly 24 is afterwards positioned over the fuel tank access aperture 20 to allow the electrical and hydraulic connections to be made to the reservoir assembly 22. Electrical connections are made using the welded-on pass-through wire harness 66 and hydraulic connections are made using the quick connect fittings of the fuel pump hose 70, auxiliary pump supply hose 72 and fuel supply hose 74. Next, the flange assembly 24 is removably secured in the fuel tank access aperture 20. The reservoir assembly 22, including the fuel pump 30, inline fuel filter assembly 34, fuel pressure regulator assembly 36 and the level sensor assembly 38 are serviceable by removing the flange assembly 24.

The installation of the fuel delivery module 14 within the fuel tank 12 in this manner allows the reservoir unit 26 to assume a greater volume and component content than in traditional fuel delivery assemblies. The dimensions of the fuel tank access aperture 20 no longer limit the size and shape of the reservoir unit 26 or any other component included in the reservoir assembly 22. Moreover, unlike prior art reservoir assemblies that utilized a reservoir unit integrally molded in one piece with a fuel tank shell, the present embodiment allows for the integration of an auxiliary pump 28, an inline fuel filter 34, a fuel pressure regulator assembly 36, a level sensor assembly 38 and the reservoir unit 26 within the non-integral reservoir assembly 22. Any design changes to the reservoir unit or other component content of the reservoir assembly 22 can be incorporated without the need for costly changes in the tooling and other process used to form the fuel tank.

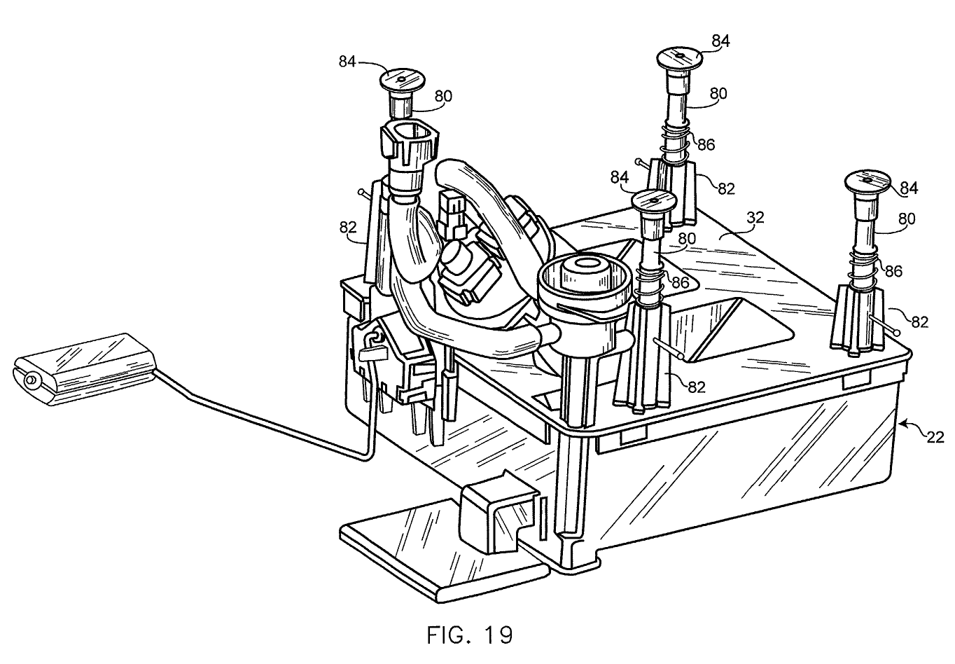

In another embodiment, according to the present invention, a plurality of support rods 80 are used to mount the reservoir assembly 22 within a fuel tank, as shown in FIG. 19. Particularly, the support rods 80 are attached at one end to the reservoir cover 32 using rod securing members 82, which are integrally formed with the reservoir cover 32. The support rods 80 extend vertically upwardly from the reservoir assembly 22 and are each provided with a rod weld foot 84 at the opposing end. After shell portions for the fuel tank are thermoformed as described above, the rod weld feet 84 are welded to a first shell portion forming the upper surface of the fuel tank in a manner similar to the welding of the weld feet 40 as discussed above. Each support rod 80 has a spring 86 about it to force the fuel delivery module 14 away from the rod weld feet 84. In order to maintain compression of the springs 86 during assembly of the reservoir assembly 22 to the first shell portion, the rod securing members 82 are provided with locking pins. Once the shell portions are welded together and the fuel tank has cooled, the locking pins are removed to allow the springs 86 to force the reservoir assembly 22 to rest on the second shell portion forming the bottom of the fuel tank.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A method for assembling a fuel delivery system comprising:
providing a reservoir assembly having a reservoir unit;
thermoforming a first shell portion and a second shell portion of a fuel tank;
fixing said reservoir assembly to one of said first and second shell portions; and
sealingly connecting said first and second shell portions to form a fuel tank to enclose said reservoir assembly within said fuel tank.

2. The method of claim 1, wherein said reservoir assembly is fixed to said one of said first shell and said second shell portions using a plurality of weld feet.

3. The method of claim 2, wherein said weld feet comprise heat-deformable structures attached to said reservoir assembly capable of forming a molecular bond with said one of said first shell and said second shell portions.

4. The method of claim 1, further comprising forming a fuel tank access aperture in at least one of said first and second shell portions for allowing access to said reservoir assembly.

5. The method of claim 4, further comprising:
providing a flange assembly;
removably securing said flange assembly to said at least one of said first and second shell portions for sealing said fuel tank, wherein said flange assembly is disposed within said fuel tank access aperture; and
removing said flange assembly after said first and second shell portions are sealingly connected together to allow access to said reservoir assembly.

6. A method for assembling a fuel delivery system comprising:
thermoforming a first shell portion and a second shell portion of a fuel tank;
providing a reservoir assembly having a reservoir unit;
fixing said reservoir assembly to one of said first and second shell portions;
sealingly connecting said first and second shell portions to form a fuel tank to at least partially enclose said reservoir assembly within said tank; and
forming a fuel tank access aperture in at least one of said first and second shell portions.

7. The method of claim 6, wherein said reservoir assembly is fixed to said one of said first shell and said second shell portions using a plurality of weld feet.

8. The method of claim 7, wherein said weld feet comprise heat-deformable structures attached to said reservoir assembly capable of forming a molecular bond with said one of said first shell and said second shell portions.

9. A fuel delivery system comprising:
a plurality of thermoformed shell portions for a fuel tank, at least one of said thermoformed shell portions having a fuel tank access aperture; and
a non-integral reservoir assembly comprising a reservoir unit, said reservoir unit having its smallest cross-sectional area being greater than the area of said fuel tank access aperture, said reservoir assembly configured to store fuel and said reservoir assembly being attached to at least one of said thermoformed shell portions inside said fuel tank.

10. The fuel delivery system of claim 9 wherein said non-integral reservoir assembly further comprises an auxiliary pump, a fuel pump, a reservoir cover, an inline fuel filter assembly, a fuel pressure regulator assembly, and a level sensor assembly mounted to said reservoir unit.

11. The fuel delivery system of claim 9 further comprising a plurality of heat-deformable weld feet capable of forming a molecular bond with said said thermoformed shell portions, wherein said reservoir assembly is attached to at least one of said thermoformed shell portions using said weld feet.

12. The fuel delivery system of claim 9 further comprising a flange assembly removably secured to said at least one of said thermoformed shell portions having a fuel tank access aperture.
